(19) United States
(12) Patent Application Publication
(10) Pub. No.: US 2020/0371900 A1
(43) Pub. Date: Nov. 26, 2020

(54) SYSTEM FOR INTELLIGENT RESTRUCTURING OF AUTOMATION TEST BEDS

(71) Applicant: BANK OF AMERICA CORPORATION, Charlotte, NC (US)

(72) Inventor: Vishal Murugesan, Chennai (IN)

(73) Assignee: BANK OF AMERICA CORPORATION, Charlotte, NC (US)

(21) Appl. No.: 16/417,259

(22) Filed: May 20, 2019

(51) Int. Cl. G06F 11/36; G06F 8/77

(52) U.S. Cl. CPC G06F 11/3684; G06F 8/77; G06F 11/3692

(57) ABSTRACT

Embodiments of the present invention provide a system for intelligent restructuring of automation test beds. The system is configured to scan a webpage associated with an entity software application to identify web elements, highlight and display web elements to a user, identify that the user is inspecting a first web element of the web elements, generate an automation step associated with the first web element, dynamically parse the automation step, and in response to dynamically parsing automation step, automatically restructure the automation test bed, in response to restructuring the automation test bed, generate a dynamic feature file, receive an input from the user to execute the dynamic feature file, in response to receiving the input, execute the dynamic feature file, and merge the process flows in the dynamic feature file into an integration and deployment pipeline.

### BACKGROUND

Conventional systems do not have the capability to support all software development models. Typically, conventional systems are designed to a certain type of software development models and with the adaptation of new software development models, conventional systems should be replaced to support the approaches used in the new software development models. As such, there exists a need for a system that supports new software development models.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for intelligent restructuring of automation test beds. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention scans a webpage associated with an entity software application, automatically identifies one or more web elements based on scanning the webpage, highlights and displays the one or more web elements to a user, identifies that the user is inspecting at least one web element of the one or more web elements, generates at least one automation step associated with the at least one web element, links the at least one automation step to the at least one web element, dynamically parses the at least one automation step, and in response to dynamically parsing the at least one automation step, automatically restructures the automation test bed.

In some embodiments, the present invention in response to restructuring the automation test bed, generates a dynamic feature file, receives an input from the user to execute the dynamic feature file, in response to receiving the input, executes the dynamic feature file.

In some embodiments, the present invention analyzes a report associated with the execution of the dynamic feature file and identifies if the report comprises at least one intentional error or at least one unintentional error based on analyzing the report.

In some embodiments, the present invention identifies that the report comprises the at least one intentional error and notify the user.

In some embodiments, the present invention identifies that the report comprises the at least one unintentional error and automatically re-execute the dynamic feature file.

In some embodiments, the present invention identifies that the report does not comprise the at least one intentional error or the at least one unintentional error and integrates the process flow associated with the dynamic feature file with an integration and deployment pipeline.

In some embodiments, the present invention generates the at least one automation step based on automation steps stored in a repository.

In some embodiments, the present invention identifies that a first automation step associated with a first web element of the one or more web elements is not stored in the repository, prompts the user to create the first automation step associated with the first web element, and stores the first automation step in the repository.

In some embodiments, the present invention restructures the automation test bed based on performing pattern matching, structural analysis, and logic evaluation.

In some embodiments, the present invention performs pattern matching, structural analysis, and logical evaluation based on creating a virtual bed application.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for intelligent restructuring of automation test beds, in accordance with an embodiment of the invention;

FIG. 2 provides a block diagram illustrating the entity system 200 of FIG. 1, in accordance with an embodiment of the invention;

FIG. 3 provides a block diagram illustrating an intelligent restructuring system 300 of FIG. 1, in accordance with an embodiment of the invention;

FIG. 4 provides a block diagram illustrating the computing device system 400 of FIG. 1, in accordance with an embodiment of the invention; and

FIGS. 5A-5B provide a flowchart illustrating a process flow for intelligent restructuring of automation test beds, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Typically, conventional systems are designed to support software development models such as waterfall method. However, all entities are currently transitioning to agile methodology and the existing systems do not support the software development process associated with the agile methodology. Software development process happens in different cycles, where new software features are added in each cycle to the existing features that were developed in the previous cycles. In the conventional systems, if an element in the already existing feature is modified in the current cycle, the user (e.g., developer) has to look for the element in the entire application that is developed until the current cycle to make the modifications. This decreases the efficiency of the software development process.

In addition to the problem above, multiple teams and multiple users work on different features in each cycle. For example, a first user from a first team works on a first feature and a second user from the second team works on a second feature and the second feature may be dependent on the first feature. In conventional systems, the first user after developing the feature may store it in a repository and the second user has to access the repository to synchronize the application in order to access the first feature, where the first user has to release the first feature for synchronization. As such, this process is time consuming and a lag exists between multiple users working on the same application.

As such, in order to overcome the aforementioned technological problems, there exists a need for system that supports the software development process associated with the agile methodology. The system of the present invention overcomes the technical challenges faced by the conventional systems.

As used herein, the terms “regression bed,” “regression test bed,” and “automation test bed” may refer to a test bed that comprises methods associated with process flow of software applications, where the methods are used for testing purposes.

In accordance with embodiments of the invention, the term “entity” may include any organization that develops and/or tests software applications. In some embodiments of the invention, the term “entity” may include any organization that processes financial transactions including, but not limited to, banks, credit unions, savings and loan associations, investment companies, stock brokerages, asset management firms, insurance companies and the like.

In accordance with embodiments of the invention, the terms “third party system” and “other third party systems” may include any organization systems that provide automation testing frameworks for testing software applications.

Furthermore, embodiments of the present invention use the term “user.” It will be appreciated by someone with ordinary skill in the art that the user may be an employee (such as an employee, contractor, sub-contractor, or the like) of the entity. In some embodiments, the user may be an automation test engineer. In some embodiments, the user may be a software developer. In some embodiments, the user may be a test engineer. In some embodiments, the “user” may be anyone who uses the system of the present invention for testing software applications.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

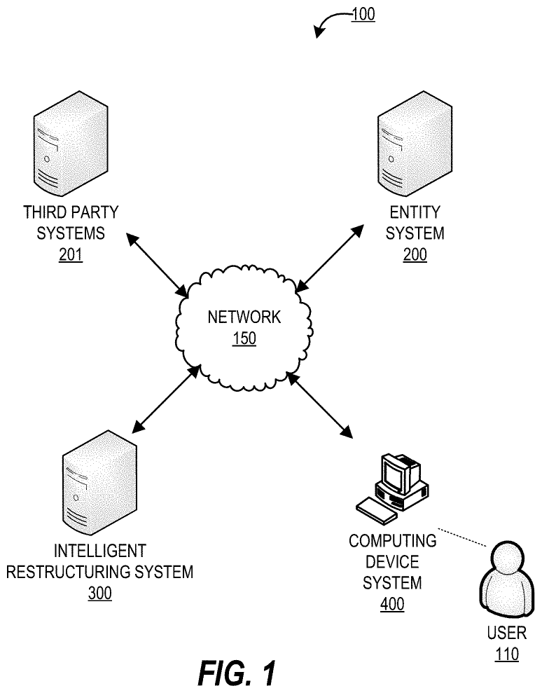

FIG. 1 provides a block diagram illustrating a system environment 100 for facilitating efficient real-time client interactions, in accordance with an embodiment of the invention. As illustrated in FIG. 1, the environment 100 includes an intelligent restructuring system 300, entity system 200, a computing device system 400, and one or more third party systems 201. One or more users 110 may be included in the system environment 100, where the users 110 interact with the other entities of the system environment 100 via a user interface of the computing device system 400. In some embodiments, the one or more user(s) 110 of the system environment 100 may be employees of the entity associated with the entity system 200.

The entity system(s) 200 may be any system owned or otherwise controlled by an entity to support or perform one or more process steps described herein. The entity may be any organization which develops or tests software applications. In some embodiments, the managing entity is a financial institution. In some embodiments, the managing entity is a non-financial institution.

The intelligent restructuring system 300 is a system of the present invention for performing one or more process steps described herein. In some embodiments, the intelligent restructuring system 300 may be an independent system. In some embodiments, the intelligent restructuring system 300 may be a part of the entity system 200.

The intelligent restructuring system 300, the entity system 200, the computing device system 400, and/or the third party systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the intelligent restructuring system 300 is configured to communicate information or instructions with the entity system 200, the computing device system 400, and/or the third party systems 201 across the network 150.

The computing device system 400 may be a system owned or controlled by the entity of the entity system 200, the user 110, and/or a third party that specializes in processing of the resource distribution applications in the system environment 100. As such, the computing device system 400 may be a computing device of the user 110. In general, the computing device system 400 communicates with the user 110 via a user interface of the computing device system 400, and in turn is configured to communicate information or instructions with the intelligent restructuring system 300, entity system 200, and/or the third party systems 201 across the network 150. In come embodiments, the computing device system 400 communicates with the user 110 via a user interface (referred to as associate interface below) of the computing device system 400, and in turn is configured to communicate information or instructions with the intelligent restructuring system 300, entity system 200, and/or the third party systems 201 across the network 150.

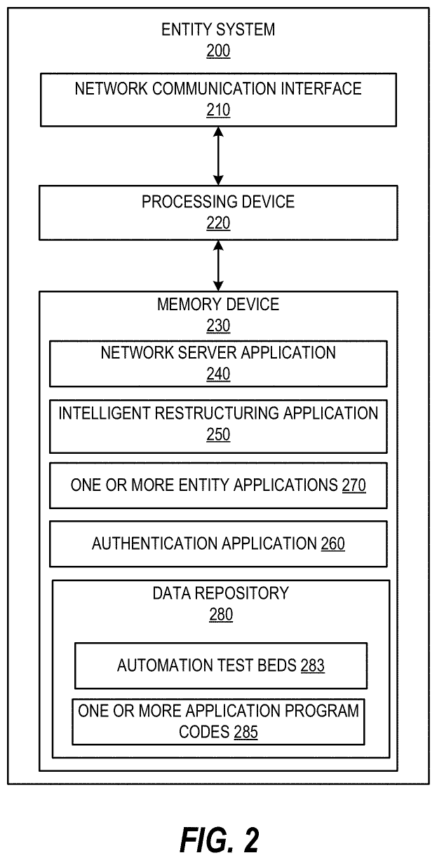

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, an intelligent restructuring application 250, one or more entity applications 270, an authentication application 260, and a data repository 280 comprises automation test beds 283 and one or more application program codes 285. The computer-executable program code of the network server application 240, the intelligent restructuring application 250, the one or more entity applications 270, and the authentication application 260 to perform certain logic, data-extraction, and data-storing functions of the entity system 200 described herein, as well as communication functions of the entity system 200.

The network server application 240, the intelligent restructuring application 250, the one or more entity applications 270, and the authentication application 260 are configured to store data in the data repository 280 or to use the data stored in the data repository 280 when communicating through the network communication interface 210 with the intelligent restructuring system 300, the computing device system 400, and/or the third party systems 201 to perform one or more process steps described herein. In some embodiments, the entity system 200 may receive instructions from the intelligent restructuring system 300 via the intelligent restructuring application 250 to perform certain operations. The intelligent restructuring application 250 may be provided by the intelligent restructuring system 300. The one or more entity applications 270 may be any of the applications used, created, modified, and/or managed by the entity system 200. The authentication application 260 may be used to authenticate one or more users 110 to access the one or more entity applications 270 and the data repository 280.

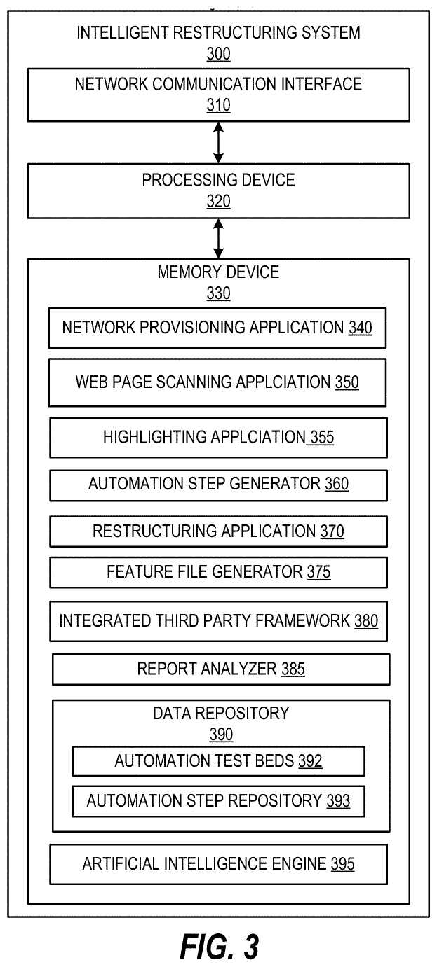

FIG. 3 provides a block diagram illustrating the intelligent restructuring system 300 in greater detail, in accordance with embodiments of the invention. As illustrated in FIG. 3, in one embodiment of the invention, the intelligent restructuring system 300 includes one or more processing devices 320 operatively coupled to a network communication interface 310 and a memory device 330. In certain embodiments, the intelligent restructuring system 300 is operated by a first entity, such as a financial institution, while in other embodiments, the intelligent restructuring system 300 is operated by an entity other than a financial institution. In some embodiments, the intelligent restructuring system 300 is owned or operated by the entity of the entity system 200. In some embodiments, the intelligent restructuring system 300 may be an independent system. In alternate embodiments, the intelligent restructuring system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the intelligent restructuring system 300 described herein. For example, in one embodiment of the intelligent restructuring system 300, the memory device 330 includes, but is not limited to, a network provisioning application 340, a webpage scanning application 350, a highlighting application 355, an automation step generator 360, a restructuring application 370, a feature file generator 375, an integrated third party framework 380, a report analyzer 385, an artificial intelligence engine 395, and a data repository 390 comprising automation test beds 392, automation step repository 393, and data processed or accessed by one or more applications in the memory device 330. The computer-executable program code of the network provisioning application 340, the webpage scanning application 350, the highlighting application 355, the automation step generator 360, the restructuring application 370, the feature file generator 375, the integrated third party framework 380, the report analyzer 385, and the artificial intelligence engine 395 may instruct the processing device 320 to perform certain logic, data-processing, and data-storing functions of the intelligent restructuring system 300 described herein, as well as communication functions of the intelligent restructuring system 300.

The network provisioning application 340, the webpage scanning application 350, the highlighting application 355, the automation step generator 360, the restructuring application 370, the feature file generator 375, the integrated third party framework 380, the report analyzer 385, and the artificial intelligence engine 395 are configured to invoke or use the data in the data repository 390 when communicating through the network communication interface 310 with the entity system 200, the computing device system 400, and/or the third party systems 201. In some embodiments, the network provisioning application 340, the webpage scanning application 350, the highlighting application 355, the automation step generator 360, the restructuring application 370, the feature file generator 375, the integrated third party framework 380, the report analyzer 385, and the artificial intelligence engine 395 may store the data extracted or received from the entity system 200, the third party system 201, and the computing device system 400 in the data repository 390.

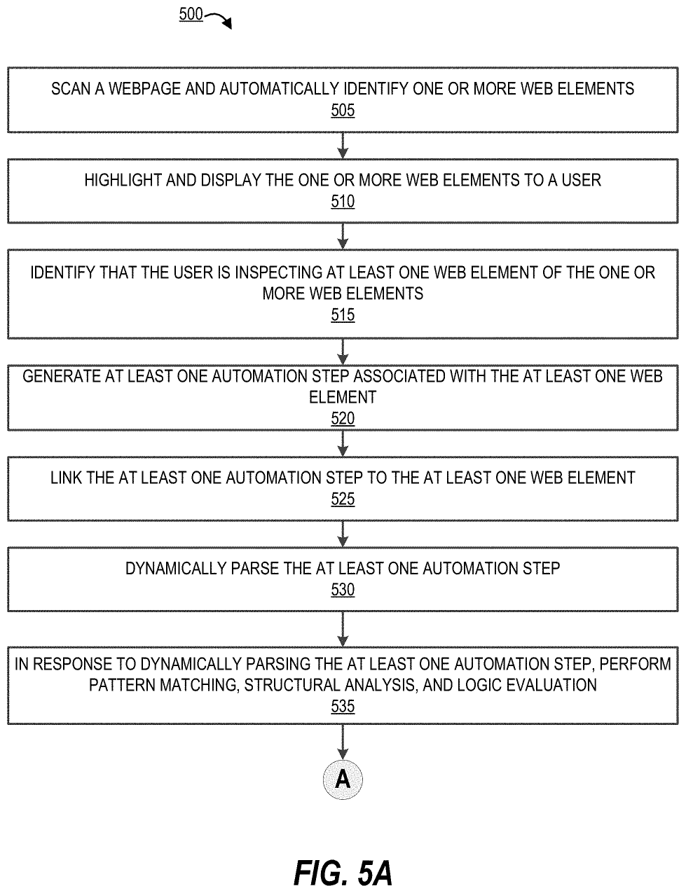

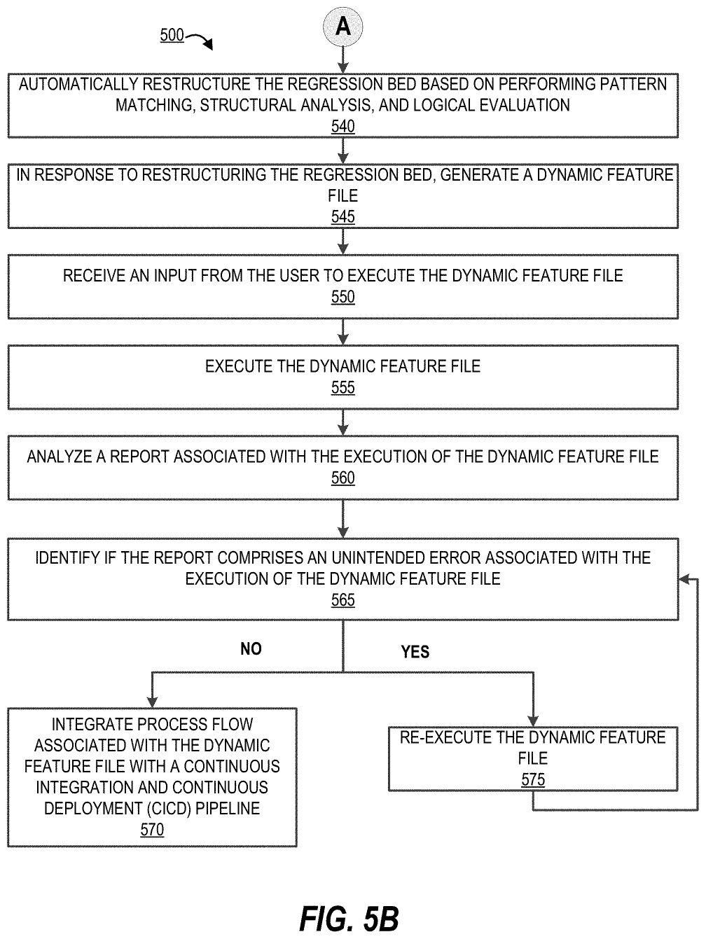

In some embodiments, the network provisioning application 340, the webpage scanning application 350, the highlighting application 355, the automation step generator 360, the restructuring application 370, the feature file generator 375, the integrated third party framework 380, the report analyzer 385, and the artificial intelligence engine 395 may store the data processed as explained in greater detail below in FIG. 5 in the data repository 390. In some embodiments, the network provisioning application 340, the webpage scanning application 350, the highlighting application 355, the automation step generator 360, the restructuring application 370, the feature file generator 375, the report analyzer 385, and the artificial intelligence engine 395 may be a part of a single application. One or more processes performed by the network provisioning application 340, the webpage scanning application 350, the highlighting application 355, the automation step generator 360, the restructuring application 370, the feature file generator 375, the integrated third party framework 380, the report analyzer 385, and the artificial intelligence engine 395 are described in detail below.

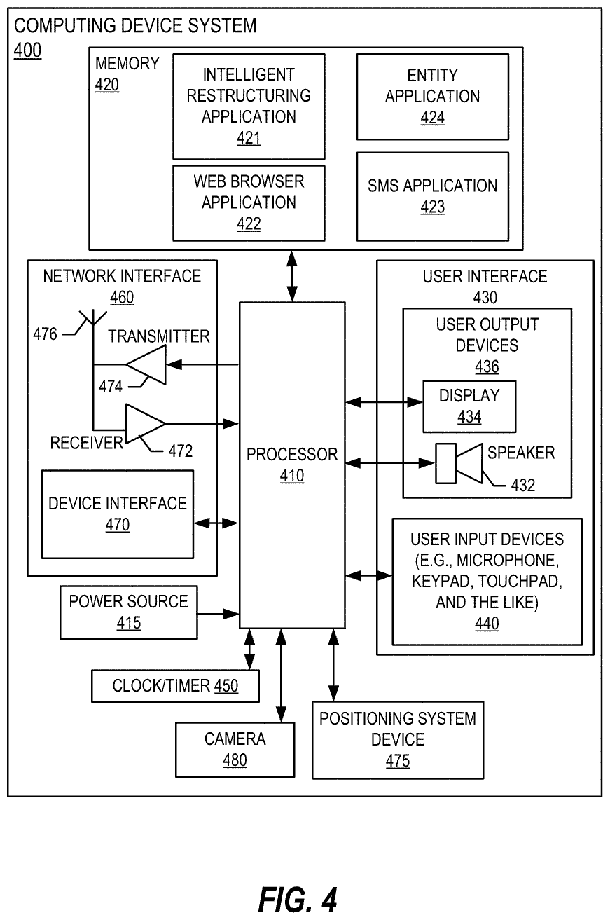

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 and/or the associate 111 may include any of a number of devices allowing the computing device system 400 to receive data from the user 110 and/or the associate 111, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a intelligent restructuring application 421, entity application 424. These applications also typically instructions to a graphical user interface (GUI) on the display 430 that allows the user 110 and/or the associate 111 to interact with the entity system 200, the intelligent restructuring system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the intelligent restructuring application 421 provided by the intelligent restructuring system 300 allows the user 110 and/or the associate 111 to access the one or more electronic resources stored in the entity system and/or the intelligent restructuring system 300. In some embodiments, the entity application 424 provided by the entity system 200 and the intelligent restructuring application 421 allow the user 110 to access one or more electronic resources and one or more entity applications 270.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIGS. 5A-5B provide a flowchart illustrating a process flow 500 for intelligently restructuring application test beds, in accordance with an embodiment of the invention. In some embodiments, the system may identify that a user is accessing a graphical user interface provided by the system on a user device of the user, the system initiates the process flow 500. As shown in block 505, the system scans a webpage and automatically identify one or more web elements. The one or more web elements may include, but not limited to, input controls, informational components, navigational components, styling elements, or the like. Input controls may include text box, button, dropdown list, hyperlink, checkbox, radio button, text fields, date fields, or the like.

As shown in block 510, the system highlights and displays the one or more web elements to a user. The system may display the highlighted one or more elements to the user on the graphical user interface provided by the system. As shown in block 515, the system identifies that the user is inspecting at least one web element of the one or more web elements. In some embodiments, the system may identify that the user is inspecting a web element based on identifying that the user is hovering over the one or more web elements. In some embodiments, the system may identify that the user is inspecting a web element based on identifying that the user has right-clicked on any of the one or more web elements.

As shown in block 520, the system generates at least one automation step associated with the at least one web element. Typically, as mentioned above, for applications developed using Behavior Driven Development (BDD) approach, testing is based on generated feature files that comprises one or more automation steps associated with the one or more web elements of a webpage. The automation steps associated with the one or more web elements are written in non-domain specific languages (e.g., common English). The system may generate the at least one automation step associated with the at least one web element based on a automation step associated with the at least one element stored in a repository. For an example, if the webpage is a login page, the system may typically have a username text box, a password text box, and a submit button which navigates the user to a different webpage upon successful authentication. The system may identify that the user is inspecting the username text box, the system may automatically generate the automation step for the text box. The simplified example disclosed above is for explanatory purposes only and does not delineate the scope of the invention.

In some embodiments, the system may identify that the user is inspecting a web element and may provide a list of automation steps related to the web element for the user to choose. The list of automation steps associated with the web elements may be multiple automation steps or definitions provided by one or more users for the same web element.

In some embodiments, the system provides keyword search feature for the user to search for automation steps associated with keywords related to web elements. Instead of inspecting the web elements, the user may choose to perform a keyword search.

If the webpage discussed in the block 505 is associated with an application that is in development stage, the automation steps of most of the one or more web elements on the web page may be present in the repository. In such an embodiment, the system automatically generates the automation steps associated with one or more web elements in the webpage. In some embodiments, the user may update an automation step of a web element and in such an embodiment, the system may update the repository with the new automation step.

If the webpage discussed in the block 505 is associated with a new application, the repository may include automation step for basic web elements. In such a case, the automation step s associated with the one or more web elements may not be present in the repository. The system may prompt the user to provide automation steps of web elements that are present in the repository.

As shown in block 525, the system links the at least one automation step to the at least one web element. The system links the at least one automation steps to at least one web element to create a flow that matches the flow written in the software code associated with the application. For example, if the software code associated with a webpage comprises multiple lines of code for login page. The system links the automation steps chosen by the user to the web elements to create a flow using the automation steps that matches the multiple lines of code written for the login page.

As shown in block 530, the system dynamically parses the at least one automation step. The system parses the at least one automation step to a virtual application bed that is created by the system, wherein the virtual application bed duplicates the features of the application that is being developed. The virtual application comprises all the features associated with the real-time production for testing purposes. The system, upon parsing the at least one automation step, breaks down the at least one automation step into screens, fields, actions, test data, and maps to the store the logical flows in the at least one automation step.

As shown in block 535, the system in response to dynamically parsing the at least one automation step, performs pattern matching, structural analysis, and logic evaluation. As shown in block 540, the system automatically restructures the regression bed based on performing pattern matching, structural analysis, and logical evaluation. The system in response to parsing the at least one automation step, matches the pattern with the existing screens, fields, test data patterns that were already developed in the previous development life cycle and identifies the changes that are to be incorporated in the existing automation test bed associated with the new requirements for the current software development life cycle. The system also performs validations and also compares actions patterns to identify the changes associated with new requirements of the current software development life cycle.

The system also performs structural analysis to verify field alignments between screens and screen alignments across the application based on comparing with the existing features and process flows stored in the automation test beds. By verifying the field alignments and screen alignments, the system ensures that the new requirements did not disturb the field alignments and screen alignments across the application. In some embodiments, the user may update the automation test bed to deal with the conflicts associated with the structural changes (i.e., anomalies in the field alignments and screen alignments). In such an embodiment, the artificial intelligence engine of the system of the present invention learns from the updates provided by the user and automatically updates the automation test bed to deal with the structural changes in the next development life cycle. The system also performs impact assessment associated with changes related to the new requirements. For example, the system may identify that a text box has been deleted in the current development lifecycle and may identify the impact of deleting the text box. The system may update the regression test bed to delete the text box from all the webpages wherever it is used. This solves the problem mentioned above and improves the efficiency of the software development process. The system restructures the automation test bed based on the pattern matching, structural analysis, and logical evaluation with the help of artificial intelligence engines and machine learning models.

As shown in block 545, the system in response to restructuring the regression bed, generates a dynamic feature file. The system generates the dynamic feature file containing the one or more automation steps from the restructured automation test bed. In the old conventional systems, feature files are created first and then stored in the regression bed, but this presents challenges while backtracking and also while modifying existing elements. Instead of storing multiple feature files for one or more features during every cycle, the system of the present invention first updates the regression bed and then creates the feature files, thereby avoiding the opening of multiple files for modifying a single element and improving the overall efficiency of the process.

As shown in block 550, the system receives an input from the user to execute the dynamic feature file. As shown in block 555, the system executes the dynamic feature file. The system executes the dynamic feature file using the third party application framework that is integrated into the system. The third party application frameworks may include any of the frameworks or software tools that are available for testing purposes. The generated feature file may be compatible with any third party application framework. In some embodiments, the system may provide options to modify the automation steps and feature files to match the requirements of the third party frameworks.

As shown in block 560, the system analyzes a report associated with the execution of the dynamic feature file. As shown in block 565, the system identifies if the report comprises an unintended error associated with the execution of the dynamic feature file. Unintended errors may include termination of the execution of the dynamic feature file due to system failures or any performance issues. In some embodiments, as shown in block 575, the system in response to identifying that the report comprises the unintended error, re-executes the dynamic feature file and the process flow is redirected to block 565 where the system identifies if the report comprises any unintended errors. In some embodiments, the system may identify that the report comprises intended errors. In such an embodiment, the system may notify the user via the graphical user interface regarding the intended error.

In some embodiments, as shown in block 570, the system in response to identifying that the report does not comprise the unintended error, integrates flow associated with the dynamic feature file with a continuous integration and continuous deployment (CICD) pipeline such that the new requirements are release into production environment.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for restructuring automation test beds, the system comprising:
at least one non-transitory storage device; and
at least one processing device coupled to the at least one non-transitory storage device, wherein the at least one processing device is configured to:
scan a webpage associated with an entity software application;
automatically identify one or more web elements based on scanning the webpage, wherein the one or more web elements comprise at least one of input controls, informational components, navigational components and styling elements;
highlight and display the one or more web elements to a user;
identify that the user is inspecting at least one web element of the one or more web elements;
generate at least one automation step associated with the at least one web element, wherein the at least one automation step is generated in a non-domain specific language;
link the at least one automation step to the at least one web element;
dynamically parse the at least one automation step to a virtual application bed; and
in response to dynamically parsing the at least one automation step to the virtual application bed, automatically restructure an automation test bed.

2. The system of claim 1, wherein the at least one processing device is further configured to:
in response to restructuring the automation test bed, generate a dynamic feature file;
receive an input from the user to execute the dynamic feature file;
in response to receiving the input, execute the dynamic feature file.

3. The system of claim 2, wherein the at least one processing device is further configured to:
analyze a report associated with the execution of the dynamic feature file; and
identify if the report comprises at least one intentional error or at least one unintentional error based on analyzing the report.

4. The system of claim 3, wherein the at least one processing device is configured to identify that the report comprises the at least one intentional error and notify the user.

5. The system of claim 3, wherein the at least one processing device is configured to identify that the report comprises the at least one unintentional error and automatically re-execute the dynamic feature file.

6. The system of claim 3, wherein the at least one processing device is configured to identify that the report does not comprise the at least one intentional error or the at least one unintentional error and integrate process flow associated with the dynamic feature file with an integration and deployment pipeline.

7. The system of claim 1, wherein the at least one processing device is configured to generate the at least one automation step based on automation steps stored in a repository.

8. The system of claim 7, wherein the at least one processing device is further configured to:
identify that a first automation step associated with a first web element of the one or more web elements is not stored in the repository;
prompt the user to create the first automation step associated with the first web element; and
store the first automation step in the repository.

9. The system of claim 1, wherein the at least one processing device is configured to restructure the automation test bed based on performing pattern matching, structural analysis, and logic evaluation.

10. The system of claim 9, wherein the at least one processing device is configured to perform pattern matching, structural analysis, and logical evaluation based on creating the virtual application bed.

11. A computer program product for restructuring automation test beds, the computer program product comprising a non-transitory computer-readable storage medium having computer executable instructions for causing a computer processor to perform the steps of:
scanning a webpage associated with an entity software application;
automatically identifying one or more web elements based on scanning the webpage, wherein the one or more web elements comprise at least one of input controls, informational components, navigational components and styling elements;
highlighting and displaying the one or more web elements to a user;
identifying that the user is inspecting at least one web element of the one or more web elements;
generating at least one automation step associated with the at least one web element, wherein the at least one automation step is generated in a non-domain specific language;
linking the at least one automation step to the at least one web element;
dynamically parsing the at least one automation step to a virtual application bed; and
in response to dynamically parsing the at least one automation step to the virtual application bed, automatically restructuring an automation test bed.

12. The computer program product of claim 11, wherein the computer executable instructions further cause the computer processor to:
in response to restructuring the automation test bed, generate a dynamic feature file;
receive an input from the user to execute the dynamic feature file;
in response to receiving the input, execute the dynamic feature file.

13. The computer program product of claim 12, wherein the computer executable instructions further cause the computer processor to:
analyze a report associated with the execution of the dynamic feature file; and
identify if the report comprises at least one intentional error or at least one unintentional error based on analyzing the report.

14. The computer program product of claim 13, wherein the computer executable instructions further cause the computer processor to identify that the report comprises the at least one unintentional error and automatically re-execute the dynamic feature file.

15. The computer program product of claim 13, wherein the computer executable instructions further cause the computer processor to identify that the report does not comprise the at least one intentional error or the at least one unintentional error and integrate a process flow associated with the dynamic feature file with an integration and deployment pipeline.

16. The computer program product of claim 11, wherein the computer executable instructions further cause the computer processor to restructure the automation test bed based on performing pattern matching, structural analysis, and logic evaluation.

17. A computerized method for restructuring automation test beds, the method comprising:
scanning a webpage associated with an entity software application;
automatically identifying one or more web elements based on scanning the webpage, wherein the one or more web elements comprise at least one of input controls, informational components, navigational components and styling elements;
highlighting and displaying the one or more web elements to a user;
identifying that the user is inspecting at least one web element of the one or more web elements;
generating at least one automation step associated with the at least one web element, wherein the at least one automation step is generated in a non-domain specific language;
linking the at least one automation step to the at least one web element;
dynamically parsing the at least one automation step to a virtual application bed; and
in response to dynamically parsing the at least one automation step to the virtual application bed, automatically restructuring an automation test bed.

18. The computerized method of claim 17, wherein the method further comprises:
in response to restructuring the automation test bed, generating a dynamic feature file;
receiving an input from the user to execute the dynamic feature file;
in response to receiving the input, executing the dynamic feature file.

19. The computerized method of claim 17, wherein the at least one automation step is generated based on automation steps stored in a repository.

20. The computerized method of claim 17, wherein restructuring the automation test bed is based on pattern matching, structural analysis, and logic evaluation.
